(19) United States
(12) Patent Application Publication
(10) Pub. No.: US 2002/0042723 A1
(43) Pub. Date: Apr. 11, 2002

(54) FDA alert monitoring and alerting healthcare network

(76) Inventors: Marion R. Rice, Rochelle, TX (US); Bindu R. Rao, Austin, TX (US)

Correspondence Address: CHRISTOPHER C. WINSLADE, 2135 N. CLIFTON AVENUE, CHICAGO, IL, 60614, US

(21) Appl. No.: 09/823,896

(22) Filed: Mar. 30, 2001

Related U.S. Application Data
(60) Provisional application No. 60/206,850, filed on May 23, 2000.

(51) Int. Cl. G06F 17/60

(52) U.S. Cl. 705/2

(57) ABSTRACT

A health care network that is used by consumers, such as doctors, patients, nurses, home health care agencies, hospitals, etc. provides access to several different kinds of information created by producers of the information. Specifically, for example, FDA alerts put out by an FDA Alert server are retrieved by the health care network, in background mode or in real-time, and presented to doctors whose patients are effected by the FDA alerts. A patient server that displays alerts to doctors, nurses, etc. while they are viewing a specific patient's information determines if any of the current (or new) FDA alerts need to be brought to the doctor or nurses attention based on information gathered by correlating FDA alerts with the patient's diagnosis, medication, etc. that are available at the patient server. In one embodiment, if the patient server determines that a doctor (or nurse) needs to be alerted to an FDA alert, it creates a communication for the doctor (or nurse) that is subsequently viewed by the doctor (or nurse) when browsing through communications.

### CROSS-REFERENCE TO RELATED APPLICATIONS

This application makes reference to, and claims priority to and the benefit of, U.S. provisional application Ser. No. 60/206,850 filed May 23, 2000.

### STATEMENT REGARDING FEDERALLY SPONSORED RESEARCH

NA

### INCORPORATION BY REFERENCE

U.S. provisional application Ser. No. 60/206,850 filed May 23, 2000 is hereby incorporated by reference herein in its entirety.

### BACKGROUND OF THE INVENTION

1. Technical Field

The present invention relates generally to patient record review by doctors and nurses, and, more specifically to alerting doctors and nurses to changes in a patient's status or in patient related information occurring due to alerts put out by Food and Drug Administration (FDA) or other similar agencies and organizations.

2. Related Art

The health care industry has computerized collection of patient data. However, doctors and nurses have to be trained in using computers before they can use computers effectively to perform their patient data analysis or monitoring. Although patient data is often collected and saved in computers, quite often the data is not easily accessible to doctor's and nurses who could use such data in determining medical care needs of their patients and in noticing changes in the medical (or other) statuses of patients. In addition, there are often no mechanisms to automatically process or analyze FDA alerts on patient care, medications, procedures, etc. and bring it to the attention of only those doctors or nurses with patients that are effected by such information.

### SUMMARY OF THE INVENTION

Aspects of the present invention may be found in an alerting healthcare network having a patient database that stores patient information regarding one or more patients, and a web server communicatively coupled to the patient database. The network also includes a healthcare provider computer, such as that of a nurse or a physician, for example, that may be communicatively coupled to the web server. The healthcare provider computer runs browser software that may be used to review patient information.

The web server evaluates healthcare alert information generated by a healthcare related agency, such as, for example, the FDA, and patient information retrieved from the patient database, and generates one or more alert messages based on the evaluation. The healthcare alert information may, for example, be periodically retrieved by the web server from another web server associated with the healthcare related agency, or may be communicated by a another web server associated with the healthcare related agency to the web server. Such communication may be in real time as the healthcare alert is generated by the healthcare related agency. Alternatively, the web server may receive the healthcare related information via manual or other input. In any case, the web server then delivers one or more web pages to the healthcare provider computer that presents one or more alert messages for review by the healthcare provider. The web page(s) may include, for example, a pop-up window for display of the alert message(s).

In one embodiment, the alert message is a warning that is based one or more of a patient's current condition, a patient's current medication, a diagnosis associated with the patient, current care being provided to the patient, or a patient's medical history. The alert message may also be based on the suitability of a patient for participation in a clinical study.

Other aspects, advantages and novel features of the present invention will become apparent from the following detailed description of the invention when considered in conjunction with the accompanying drawings.

### BRIEF DESCRIPTION OF THE DIAGRAMS

The numerous objects and advantages of the present invention may be better understood by those skilled in the art by reference to the accompanying figures in which:

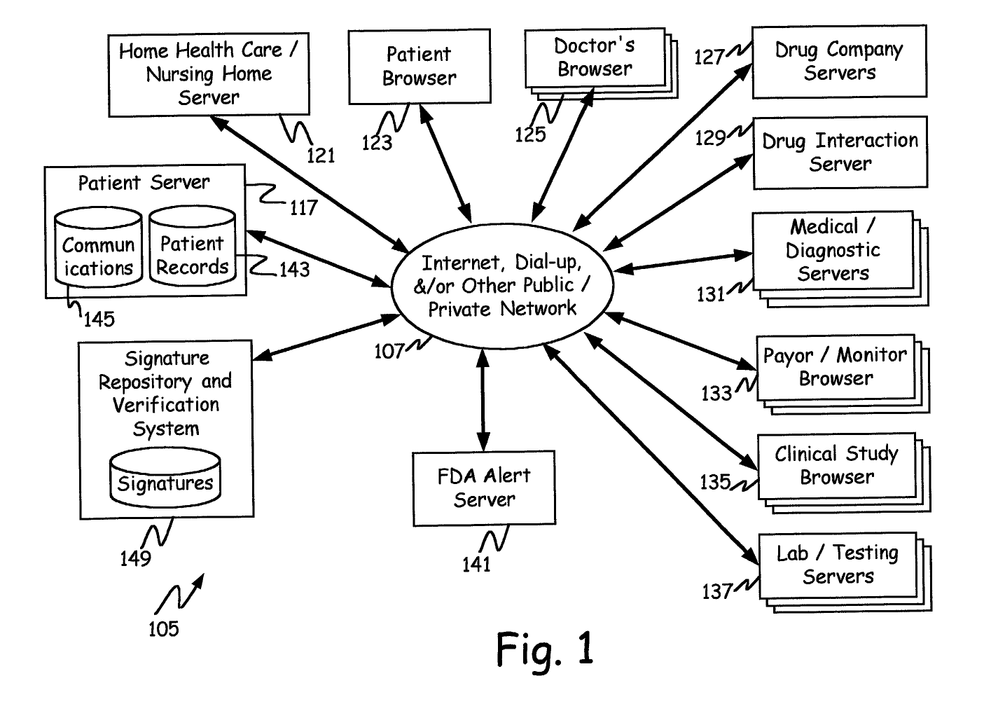

FIG. 1 is a perspective diagram of an FDA alert monitoring and alerting healthcare network that facilitates online retrieval of various FDA alerts and the selective delivery of such alerts to doctor's, nurses and/or agencies based on patient information, patient medication prescriptions, etc.;

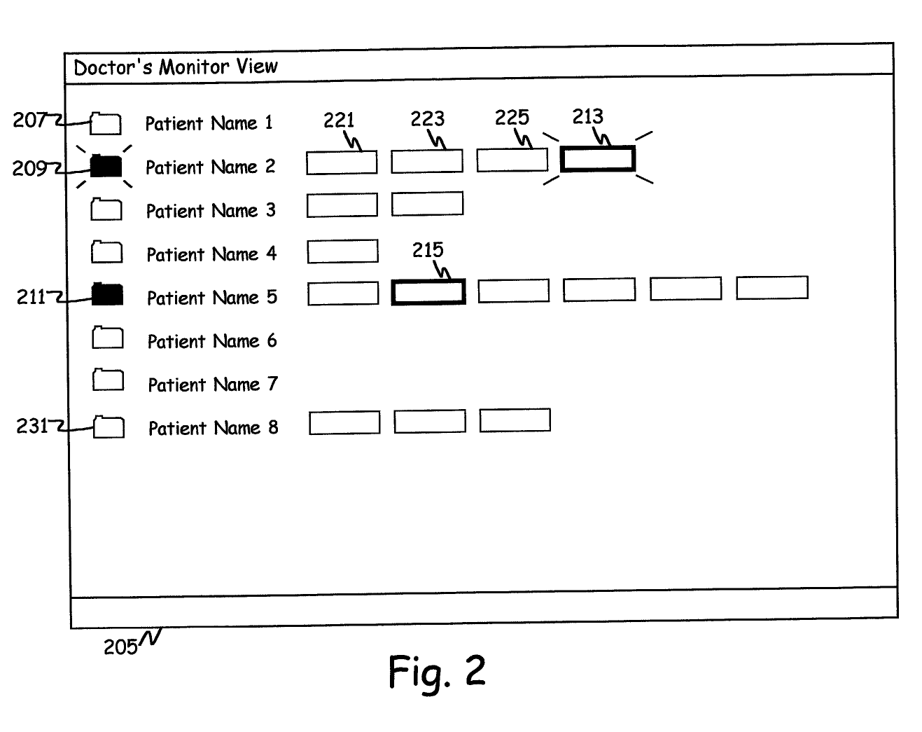

FIG. 2 is a perspective diagram of a doctor's monitor view window displayed on a doctor's browser that alerts a doctor to important information and status changes associated with specific patients of the doctor, such as FDA alerts issued by FDA via the FDA Alert Server that are relevant to the patient's medications or the patient's diagnosis or to the care being provided to the patient;

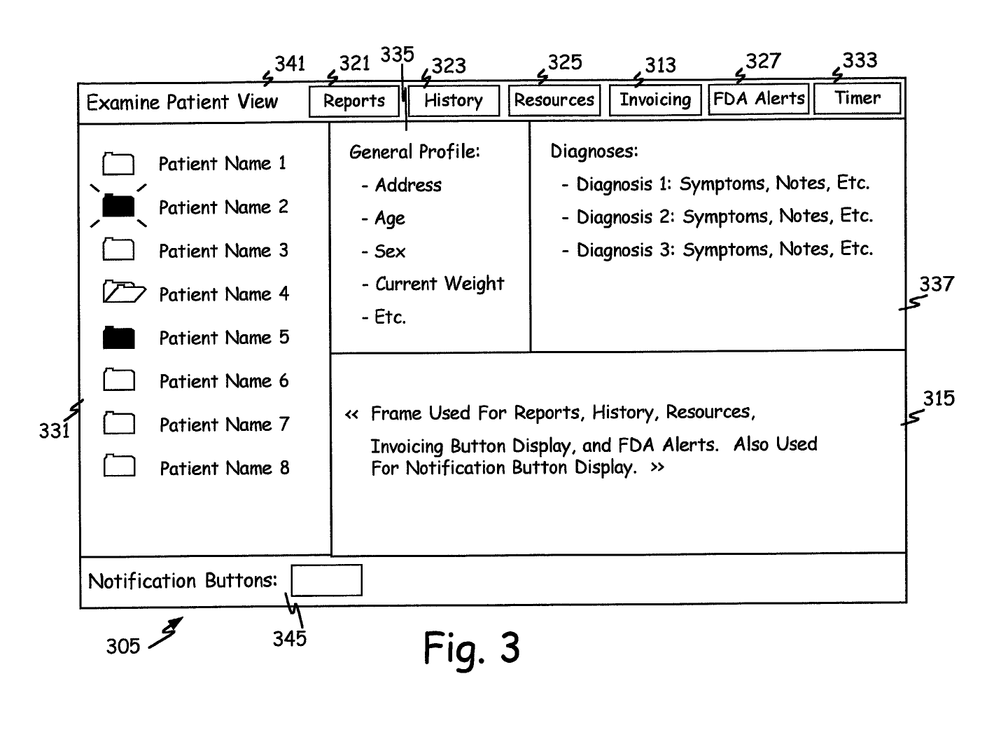

FIG. 3 is a perspective diagram of a Examine Patient View window that displays, among other information, a list of patients in a patient list frame, the patient's general profile in a general profile frame, a list of diagnosis and associated symptoms for the patient in a diagnosis frame, and reports, history, resources, invoicing, notification, alerts, etc. in a details frame; and

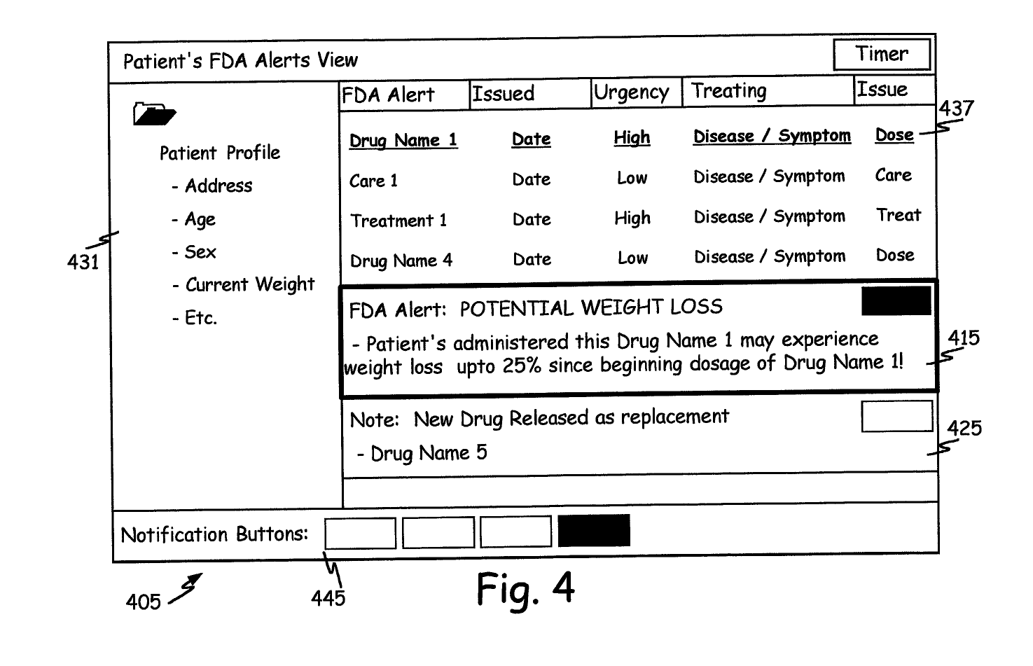

FIG. 4 is a perspective diagram that shows a Patient's FDA Alerts View window using which a patient, care provider, or a doctor reviews FDA alerts that are relevant to the patient.

### DETAILED DESCRIPTION OF THE INVENTION

FIG. 1 is a perspective diagram of an FDA alert monitoring and alerting healthcare network 105 that facilitates online retrieval of various FDA alerts and the selective delivery of such alerts to doctor's, nurses and/or agencies based on patient information, patient medication prescriptions, etc.

The FDA alert monitoring and alerting healthcare network 105 also facilitates retrieval of various alerts issued by FDA, patient, medication and medical care related information from a plurality of sources, to present them to a plurality of consumers, such as a doctor who uses a doctor's browser 125, a payor/monitor browser 133, a clinical study browser 135 or from a patient using a patient's browser 123.

The FDA alert monitoring and alerting healthcare network 105 comprises a plurality of sources of alerts, etc. including: a home health care/nursing home server 121; a drug company servers 127; a drug interaction server 129; medical/diagnostic servers 131; lab/testing servers 137; an FDA Alert server 141 for FDA alerts; and a patient server 117. Communication between the various producers and consumers of various alerts, patient, medical drugs and medical care related information is facilitated by an Internet, Dial-up, &/or Other public/Private Network 107.

While reviewing patient records retrieved from the patient records database 119 over the doctor's browser 125, the doctor is selectively provided with alerts associated with changes that are automatically detected in the patient's condition, patient's drug prescriptions, etc. Such alerts are typically detected by the patient server 117 based on reviewing patient's records, patient's profile, etc. and correlating such information (patient's records and patient's profile, etc.) with: medication alerts, patient care alerts and other alerts available from FDA Alert server 141; drug intervention information available from drug intervention server 129; and, information available in medical/diagnostic servers 131, etc.

In one embodiment, if the patient server determines that a doctor (or nurse) needs to be alerted to an FDA alert, it creates communication for the doctor (or nurse) that is subsequently viewed by the doctor (or nurse) when browsing through his communications.

One of the advantages of such a FDA alert monitoring and alerting healthcare network 105 is the ability of the doctor, over the doctor's browser and interacting with the patient server 117, to automatically determine if any of his patients are effected by alerts issued by FDA, such alerts being periodically made available via the FDA Alert server 141.

In one embodiment, the patient server 117 typically accesses alert information from the FDA Alert Server 141 employing one or more of several different ways: by periodically retrieving FDA alerts from the FDA Alert server 141; by interacting in real-time with the FDA alert server 141 to retrieve only those alert records that are relevant to a specific patient's medications, diagnosis and/or care related information; by retrieving alerts from the FDA Alert server 141 based on a specific medication or a specific diagnosis and subsequently creating communications for only those doctors associated with the patients diagnosed with that specific diagnosis or being administered the specific medication or similar medication, etc.

In another embodiment, after periodically retrieving FDA alerts from the FDA Alert server 141, the patient server 117 processes the retrieved FDA alerts to determine the patients who are effected by those alerts, based on their current medications, diagnosis and/or care related information that are retrieved from a patient records database 143. Then, for each of these patients, the patient server 117 creates FDA alert communications in a communications database 145 for the associated doctors, and subsequently causes the display of these alerts as communications when the doctor reviews his communication using the doctor's browser. Similarly, nurses or other care providers can review FDA alerts by retrieving them as communications along with patient records while monitoring or reviewing patient records using a nurses browser. Payor/Monitor agents can also review FDA alerts using the payor/monitor browser 133 as communications, when such FDA alerts are forwarded to them as communications by the patient server 117.

FIG. 2 is a perspective diagram of a doctor's monitor view window 205 displayed on a doctor's browser that alerts a doctor to important information and status changes associated with specific patients of the doctor, such as FDA alerts issued by FDA via the FDA Alert Server 141 that are relevant to the patient's medications or the patient's diagnosis or to the care being provided to the patient. The doctor's monitor view window 205 comprises of a frame or panel that displays a lists of patient information, each entry in the list, such as entry 207 and 209, occupying a row of information displaying a folder icon, patient name, and various status boxes. For example, patient 209 displayed on the second row has status boxes 221, 223, 225 and 213, one of which, 213, is highlighted to suggest the presence of a new FDA alert that requires the doctor's attention.

In general, patient records that require a doctor's attention are highlighted by a folder icon (209 and 211) which is significantly different from those (207, 231) that do not require a doctor's attention. By double clicking on the folder icons 209, 211 that are highlighted, or on the other folders that are not highlighted, such as on folder 207, the doctor can view details of the patient's record in a pop-up/new window. Similarly, by double clicking or selecting highlighted status boxes 213, 215, the doctor can view details related to that status box in a pop-up up/new window.

Typically, the monitor view window 205 is generated as a hypertext markup language (HTML) file or an XML file by the patient server 117 and displayed on the doctor's browser 125. The patient server 117 generates this html file or XML file based on the patient's records available in the patient records database 143, the correlation of drug interaction information associated with the patient's record and the drug interaction information available at the drug interaction server 129, the patient's information available at the lab/testing servers 137, the FDA alerts that are relevant to the patient's medications, diagnosis, medical care, etc. Specifically, if during the generation of the html file or XML file, the patient server 117 discovers that a clinical study or research is being conducted in which the patient could participate, this fact is brought to the doctor's attention by creating a corresponding highlighted box in the html file or XML file.

While the doctor is viewing a patient's information in the Doctor's monitor view window, he can double click on the folder icons 209, 211 that are highlighted, or on the other folders that are not highlighted, such as on folder 207, to view details of the patient's record in a pop-up/new window, called the Examine Patient View window.

FIG. 3 is a perspective diagram of a Examine Patient View window 305 that displays, among other information, a list of patients in a patient list frame 331, the patient's general profile in a general profile frame 335, a list of diagnosis and associated symptoms for the patient in a diagnosis frame 337, and reports, history, resources, invoicing, notification, alerts, etc. in a details frame 315. In addition, a top button bar 341 provides a number of buttons that causes the display of various information, when activated, in the details frame 315, such as a Reports button 321 for the display of reports, a History button 323 that shows the history of care and medicine given for the patient, a Resources button 325 that displays resources assigned towards provision of care to the patient, an Invoicing button 313 that displays invoicing information, and an FDA Alerts button 327 that opens up a Patient's FDA Alerts View window when activated. In addition, a Timer button 333 provides control on time invested by the doctor in reviewing the patient's view information.

In one embodiment, when the doctor opens the examine patient view window 305, the amount of time taken by the doctor in examining the patient's records is monitored and saved, for billing purposes with the use of a timer clock (not shown) associated with the Examine Patient View window 305. Patient record viewing time is accrued until one of several termination events occur, such as the doctor selecting another patient's name for review on the patient list frame 339, which resets the timer clock for the selected patient; the doctor activating the Timer button 333 that stops the Timer clock and starts the Timer clock in a toggle mode of operation; closing of the examine patient view window 305; terminating the review counter clock at the end of a period of inactivity; etc.

The Examine Patient View 305 is used by a doctor on the doctor's browser 125 as well as by nurses or care providers on the nurses'computer to view the patient's diagnosis, FDA alerts, the history of care given, etc., before/while examining a patient or administering patient care services. The general profile of the patient, including the patient's name, address, sex, age, current weight, etc. is displayed in the general profile frame 335, and a list of diagnosis and associated symptoms are displayed in the diagnosis frame 337.

FIG. 4 is a perspective diagram that shows a Patient's FDA Alerts View window 405 using which a patient, care provider, or a doctor reviews FDA alerts that are relevant to the patient. The relevance of specific FDA alerts to a patient is determined by the patient server 117, based on correlation of diagnosis, patient care information, medication, drug usage information, etc. with the FDA alerts retrieved from the FDA server. The Patient's FDA Alerts View window 405 comprises a patient profile frame 421 in which the patient's name, age, address, sex, current weight, medical condition, etc are displayed; an FDA alert list frame 437 in which a list of various FDA alerts, their issue date, urgency, the treatment category such as the associated disease and symptoms, and the alert category are displayed; a warning display frame 415 for displaying potential FDA alert warnings, such as, for example, potential weight loss due to a specific medication; and a details frame 425. Notification buttons are also provided in a bottom panel 445, that, when activated, cause the display of notification details in the details frame 425.

Although the Patient's FDA Alert View window 405 incorporates more than one frame, each with its own content, an alternative embodiment may employ a single frame to display all the content. In addition, one or more categories of FDA alerts are retrieved from the FDA Alert server and employed to determine those that are relevant to a patient for display purposes. The retrieval of alerts from the FDA Alert server is performed by the patient server 117 either in a background mode periodically and/or at in real-time for each individual patient (based on patient's profile and patient related information).

Although a system and method according to the present invention has been described in connection with the preferred embodiment, it is not intended to be limited to the specific form set forth herein, but on the contrary, it is intended to cover such alternatives, modifications, and equivalents, as can be reasonably included within the spirit and scope of the invention as defined by this disclosure and appended diagrams.

1. An alerting healthcare network comprising:
healthcare alert information generated by a healthcare related agency;
a patient database that stores patient information regarding a patient;
a first web server communicatively coupled to the patient database that evaluates the healthcare information and the patient information and generates at least one alert message based on the evaluation;
a healthcare provider computer, communicatively coupled to the web server, running browser software used by the healthcare provider to review the patient information; and
at least one web page delivered by the web server to the healthcare provider computer that presents the at least one alert message for review by the healthcare provider.

2. The alerting healthcare network of claim 1 wherein the healthcare related agency is the FDA.

3. The alerting healthcare network of claim 1 further comprising a second web server associated with the healthcare related agency, and wherein the first web server receives the healthcare alert information from the second web server.

4. The alerting healthcare network of claim 3 wherein the first web server periodically retrieves the healthcare alert information from the second web server.

5. The alerting healthcare network of claim 3 wherein the second web server communicates the healthcare alert information to the first web server in real time when the healthcare information is generated.

6. The alerting healthcare network of claim 1 wherein the alert message comprises a warning based on one or more of a current condition of the patient, a current medication of the patient, a diagnosis associated with the patient, current care being provided to the patient, and a medical history of the patient.

7. The alerting healthcare network of claim 1 wherein the healthcare provider computer is one of a physician computer or a nurse computer.

8. The alerting healthcare network of claim 1 wherein the at least one web page presents a pop-up window for display of the at least one alert message.

9. The alerting healthcare network of claim 1 wherein the first web server is at a location remote from healthcare provider computer.

10. The alerting healthcare network of claim 3 wherein the first web server is at a location remote from the second web server.

11. The alerting healthcare network of claim 1 wherein the alert message is based on a suitability of the patient for participation in a clinical study.

12. An alerting healthcare network comprising:
healthcare alert information generated by a healthcare related agency;
a patient database that stores patient information regarding a plurality of patients;
a first web server communicatively coupled to the patient database that evaluates the healthcare information and the patient information, and based on the evaluation, generates an alert message for each of selected ones of the plurality of patients;
a plurality of healthcare provider computers, each corresponding to a respective one of the plurality of patients, communicatively coupled to the web server, and running browser software used by a healthcare provider to review patient information regarding the respective one of the plurality of patients; and
the first web server delivering at least one web page to selected ones of the plurality of healthcare provider computers, each of the selected ones of the plurality of healthcare provider computers corresponding to a respective selected one of the plurality of patients, each at least one web page presenting the alert message for review by a healthcare provider.

13. The alerting healthcare network of claim 12 wherein the healthcare related agency is the FDA.

14. The alerting healthcare network of claim 12 further comprising a second web server associated with the healthcare related agency, and wherein the first web server receives the healthcare alert information from the second web server.

15. The alerting healthcare network of claim 14 wherein the first web server periodically retrieves the healthcare alert information from the second web server.

16. The alerting healthcare network of claim 14 wherein the second web server communicates the healthcare alert information to the first web server in real time when the healthcare information is generated.

17. The alerting healthcare network of claim 12 wherein each alert message comprises a warning based on or more of a current condition of the respective selected one of the plurality of patients, a current medication of the respective selected one of the plurality of patients, a current diagnosis for the respective selected one of the plurality of patients, current care being provided to the respective selected one of the plurality of patients, and a medical history of the respective selected one of the plurality of patients.

18. The alerting healthcare network of claim 12 wherein each of the plurality of healthcare provider computers is one of a physician computer or a nurse computer.

19. The alerting healthcare network of claim 12 wherein the at least one web page presents a pop-up window for display of the alert message.

20. The alerting healthcare network of claim 12 wherein the first web server is at a location remote from at least a portion of the plurality of healthcare provider computers.

21. The alerting healthcare network of claim 14 wherein the first web server is at a location remote from the second web server.

22. The alerting healthcare network of claim 12 wherein the alert message is based on a suitability of the respective selected one of the plurality of patients for participation in a clinical study.

23. A method of providing an alert in an alerting healthcare system comprising:
retrieving patient information from a patient database regarding a patient;
receiving healthcare alert information generated by a healthcare related agency;
determining whether an alert is warranted for the patient based on the retrieved patient information and the healthcare alert information;
communicating an alert message to a physician computer if it is determined that an alert is warranted for the patient.

24. The method of claim 23 further comprising causing the alert message to be displayed on the physician computer.

25. The method of claim 23 further comprising communicating, by the healthcare related agency, the healthcare alert information.

26. The method of claim 23 wherein the healthcare alert information is retrieved from the healthcare related agency.

27. A method of providing alerts in an alerting healthcare system comprising:
retrieving patient information from a patient database regarding each of a plurality of patients;
receiving healthcare alert information generated by a healthcare related agency;
determining whether an alert is warranted for the each of the plurality of patients based on the retrieved patient information and the healthcare alert information;
communicating an alert message to a respective physician computer, for each of the plurality of patients for whom it is determined that an alert is warranted.

28. The method of claim 27 further comprising causing the alert message to be displayed on each respective physician computer.

29. The method of claim 27 further comprising communicating, by the healthcare related agency, the healthcare alert information.

30. The method of claim 27 wherein the healthcare alert information is retrieved from the healthcare related agency.
